(19) United States
(12) Patent Application Publication
(10) Pub. No.: US 2018/0322972 A1
(43) Pub. Date: Nov. 8, 2018

(54) SYSTEM AND METHOD FOR MAKING A SOLID TARGET WITHIN A PRODUCTION CHAMBER OF A TARGET ASSEMBLY

(71) Applicant: General Electric Company, Schenectady, NY (US)

(72) Inventors: Martin Pärnaste, Uppsala (SE); Fredrik Rensei, Uppsala (SE); Katherine Gagnon, Uppsala (SE); Mikael Carlbom, Uppsala (SE); Tomas Eriksson, Uppsala (SE)

(21) Appl. No.: 15/586,696

(22) Filed: May 4, 2017

(51) Int. Cl. G21G 1/10; H05H 13/00; H05H 7/14; H05H 13/02

(52) U.S. Cl. CPC G21G 1/10; H05H 13/005; H05H 2007/088; H05H 13/02; H05H 7/14

(57) ABSTRACT

System includes a target assembly having a production chamber. The target assembly includes an electrode and a conductive base exposed to the production chamber. The target assembly has fluidic ports that provide access to the production chamber. The system also includes a fluidic-control system having a storage vessel and fluidic lines that connect to the fluidic ports. The storage vessel and the production chamber are in flow communication through at least one of the fluidic lines. The system also includes a power source that is configured to be electrically connected to the electrode and the conductive base. The production chamber, the electrode, and the conductive base form an electrolytic cell when an electrolytic solution is disposed in the production chamber. The power source is configured to apply voltage to the electrode and the conductive base to deposit a solid target along conductive base.

### BACKGROUND

The subject matter disclosed herein relates generally to isotope production systems, and more particularly to isotope production systems having a target material that is irradiated with a particle beam.

Radioisotopes (also called radionuclides) have several applications in medical therapy, imaging, and research, as well as other applications that are not medically related. Systems that produce radioisotopes typically include a particle accelerator, such as a cyclotron, that accelerates a beam of charged particles (e.g., H— ions) and directs the beam into a target material to generate the isotopes. The cyclotron is a complex system that uses electrical and magnetic fields to accelerate and guide the charged particles along a predetermined orbit within an acceleration chamber. When the particles reach an outer portion of the orbit, the charged particles form a particle beam that is directed toward a target assembly that holds the target material for isotope production.

The target material is contained within a chamber of the target assembly. The target assembly forms a beam passage that receives the particle beam and permits the particle beam to be incident on the target material in the chamber. To contain the target material within the chamber, the beam passage is separated from the chamber by one or more foils. For example, the chamber may be defined by a void within a target body. A target foil covers the void on one side and a section of the target assembly may cover the opposite side of the void to define the chamber therebetween. The particle beam passes through the target foil and is incident upon the target material.

Different types of target material may require different target assemblies. Target assemblies designed for irradiating solid metals and/or pressed metal powders typically need a supporting system for transferring the target material to be irradiated to and from the chamber. This often involves large diameter hoses where a “shuttle” holding the material to be irradiated is pushed by means of compressed air or similar to and from the target itself. These surrounding systems are typically bulky and require large access areas to fit. At least some cyclotron designs lack available space for such target assemblies. It is also generally desirable to have less bulky designs.

### BRIEF DESCRIPTION

In an embodiment, a system is provided that includes a target assembly having a production chamber. The target assembly includes an electrode and a conductive base exposed to the production chamber. The target assembly has fluidic ports that provide access to the production chamber. The system also includes a fluidic-control system having a storage vessel configured to hold an electrolytic solution and fluidic lines that connect to the fluidic ports of the target assembly. The storage vessel and the production chamber of the target assembly are in flow communication through at least one of the fluidic lines. The system also includes a power source configured to be electrically connected to the electrode and the conductive base. The production chamber, the electrode, and the conductive base form an electrolytic cell when the electrolytic solution is disposed in the production chamber. The power source is configured to apply voltage to the electrode and the conductive base to deposit a solid target along conductive base.

In some aspects, the target assembly includes an intermediate body section disposed between the electrode and the conductive base. The intermediate body section is insulative. The intermediate body section may be secured to the electrode and the conductive base and, collectively, may define the production chamber.

In some aspects, the system also includes one or more circuits or processors configured to induce a flow, using the fluidic-control system, of the electrolytic solution into the production chamber. The one or more circuits or processors are also configured to apply, using the power source, the voltage to the target assembly thereby depositing metal ions onto the conductive base. The one or more circuits or processors are also configured to induce a flow, using the fluidic-control system, of the electrolytic solution out of production chamber after the voltage has been applied. The target assembly may include the intermediate body section disposed between the electrode and the conductive base. Optionally, the one or more circuits or processors are configured to, while the voltage is applied, at least one of (a) induce a flow of the electrolytic solution within the production chamber or (b) activate a vibrating device that causes vibrations within the production chamber.

In some aspects, the target assembly includes a foil that covers an opening to the production chamber. The foil defines a portion of the production chamber.

In some aspects, the target assembly includes an opening to the production chamber that is configured to receive a particle beam. The conductive base is aligned with the opening such that the particle beam is incident upon the solid target along the conductive base.

In an embodiment, a system (e.g., an isotope production system) is provided that includes a particle accelerator configured to generate a particle beam and a target assembly having a production chamber. The target assembly includes an electrode and a conductive base exposed to the production chamber. The target assembly has fluidic ports that provide access to the production chamber. The system also includes a fluidic-control system having a storage vessel configured to hold an electrolytic solution and fluidic lines that connect to the fluidic ports of the target assembly. The storage vessel and the production chamber of the target assembly are in flow communication through at least one of the fluidic lines. The system also includes a power source configured to be electrically connected to the electrode and the conductive base. The production chamber, the electrode, and the conductive base form an electrolytic cell when the electrolytic solution is disposed in the production chamber. The fluidic-control system includes at least one pump in flow communication with the production chamber. The at least one pump is configured to induce a flow of the electrolytic solution into the production chamber and, after voltage has been applied by the power source, induce a flow of the electrolytic solution out of the production chamber.

In some aspects, the system also includes a control system including one or more processors and a storage medium that is configured to store programmed instructions accessible by the one or more processors. The one or more processors are configured to control the at least one pump and the power source to induce the flow of the electrolytic solution into the production chamber and apply the voltage to the target assembly thereby depositing a solid target along the conductive base. The one or more processors are also configured to induce the flow of the electrolytic solution out of production chamber after the voltage has been applied.

Optionally, the control system is configured to control the particle accelerator to direct the particle beam onto the solid target within the production chamber. Optionally, the electrolytic solution is a second electrolytic solution and wherein, prior to the solid target being deposited, the one or more processors are configured to control the at least one pump and the power source to induce a flow of a first electrolytic solution into the production chamber and apply a voltage to the target assembly thereby depositing a base layer along the conductive base. The one or more processors are also configured to induce the flow of the first electrolytic solution out of production chamber after the voltage has been applied, wherein the solid target is deposited along the base layer.

In some aspects, the target assembly includes an intermediate body section disposed between the electrode and the conductive base. The intermediate body section is insulative.

In some aspects, after the particle beam is directed onto the solid target, the at least one pump is configured to induce a flow of dissolving solution into the production chamber. The dissolving solution is configured to dissolve the solid target into the solution after the solid target has been activated by the particle beam.

In some aspects, the target assembly includes an opening to the production chamber that is configured to receive a particle beam. The conductive base is aligned with the opening such that the particle beam is incident upon the solid target along the conductive base.

In some aspects, the at least one pump is configured to, while the voltage is applied, at least one of (a) induce a flow of the electrolytic solution within the production chamber or (b) hold the electrolytic solution in a substantially static manner within the production chamber.

In an embodiment, a method of generating a solid target is provided. The method includes flowing an electrolytic solution into a production chamber of a target assembly. The target assembly includes an electrode and a conductive base positioned in the production chamber. The production chamber, the electrode, the conductive base, and the electrolytic solution form an electrolytic cell. The method also includes applying a voltage to the target assembly thereby depositing a solid target along the conductive base. The method also includes flowing the electrolytic solution out of production chamber after the voltage has been applied.

In some aspects, the target assembly includes an intermediate body section disposed between the electrode and the conductive base. The intermediate body section is insulative.

In some aspects, the method also includes controlling a particle accelerator to direct a particle beam onto the solid target within the production chamber. After the particle beam is directed onto the solid target, the method also includes removing the activated material of the solid target. For example, the method may include flowing a dissolving solution into the production chamber. The dissolving solution is configured to dissolve the solid target into the solution after the solid target has been activated by the particle beam.

In some aspects, the method also includes venting gases that are generated within the production chamber as the voltage is applied to the target assembly.

In some aspects, the method also includes, while the voltage is being applied, moving the electrolytic solution within the production chamber.

### BRIEF DESCRIPTION OF THE DRAWINGS

FIG. 1 is a block diagram of an isotope production system in accordance with an embodiment.

FIG. 2 is a side view of an extraction system and a target system in accordance with an embodiment.

FIG. 3 is a rear perspective view of a target assembly in accordance with an embodiment.

FIG. 4 is front perspective view of the target assembly of FIG. 3.

FIG. 5 is an exploded view of the target assembly of FIG. 3.

FIG. 6 is an exploded view of the target assembly of FIG. 3 from another perspective.

FIG. 7 is a cross-section of a target assembly formed in accordance with an embodiment.

FIG. 8 is a cross-section of the target assembly when a production chamber has been filled with electrolytic solution.

FIG. 9 is a cross-section of the target assembly during irradiation with a particle beam.

FIG. 10 is a cross-section of the target assembly after irradiation with a particle beam and filled with a dissolving solution.

FIG. 11 is a method of generating a solid target in accordance of an embodiment.

### DETAILED DESCRIPTION

The foregoing summary, as well as the following detailed description of certain embodiments will be better understood when read in conjunction with the appended drawings. To the extent that the figures illustrate diagrams of the blocks of various embodiments, the blocks are not necessarily indicative of the division between hardware. Thus, for example, one or more of the blocks may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Embodiments set forth herein are configured to generate a solid target that may be used to prepare radioisotopes (also called radionuclides or radiopharmaceuticals) for medical imaging, scientific research, therapy, or other possible applications. Unlike conventional target preparation in which the solid target is prepared on a separate plate or backing that is then loaded into a target assembly, embodiments set forth herein may generate the solid target in situ or, in other words, generate the solid target within the same target body that is used to irradiate the solid target. For example, the solid target may be electroplated at the same position within a target body that is subsequently irradiated by a particle beam.

In particular embodiments, the solid target may be generated within the isotope production system that is used to irradiate the solid target. For systems having multiple target assemblies, the solid target may be generated within a target assembly while another target assembly is being prepared for irradiation, is being irradiated, or is having the activated material removed. In other embodiments, the solid target is generated within a target body of a target assembly that is separate from the isotope production system. The target assembly may then be operably coupled to the isotope production system.

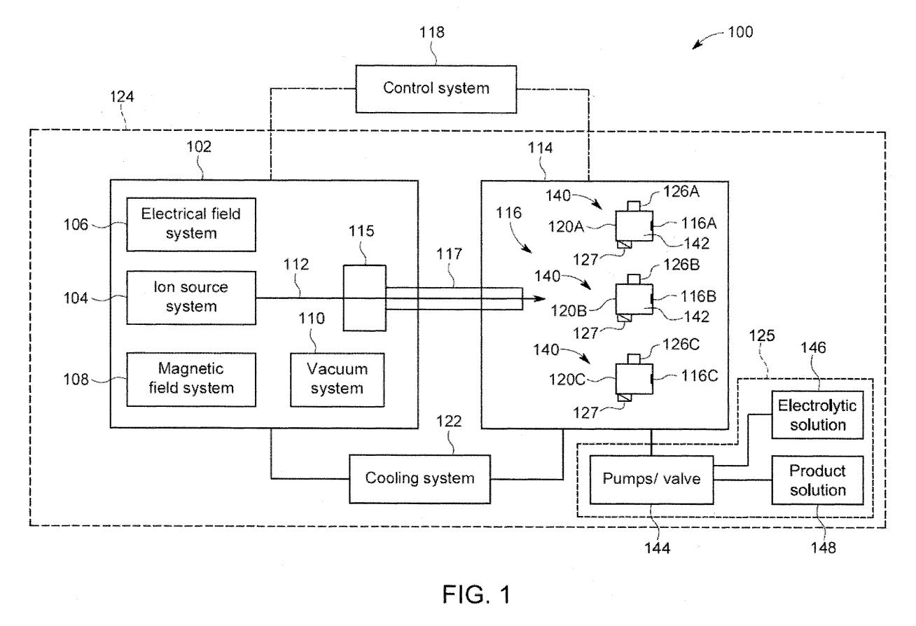

FIG. 1 is a block diagram of a system 100 formed in accordance with an embodiment. In particular embodiments, the system 100 is an isotope production system 100 that includes a particle accelerator 102 (e.g., cyclotron) having several sub-systems including an ion source system 104, an electrical field system 106, a magnetic field system 108, a vacuum system 110, a cooling system 122, a target system 114, and a fluidic-control system 125. However, embodiments may have fewer sub-systems. For example, in some embodiments, the system 100 may include a target assembly, a fluidic-control system, and a power source. The target system 114 may include one or more target assemblies 140. In the illustrated embodiment, the target system 114 includes a plurality of target assemblies 140. Each of the target assemblies 140 has a target body 142 that may include a plurality of sections secured to one another. The target body 142 has a production chamber 120 therein where a target material 116 is located. A particle beam 112 is generated by the particle accelerator 102 and directed onto the target material 116, thereby generating designated isotopes. As described herein, the target material 116 may be a solid target that is generated through an electroplating process that occurs within the corresponding production chamber 120. In some embodiments, however, one or more of the target assemblies 140 may be configured to support a liquid or gas target.

During use of the isotope production system 100, the target material 116 (e.g., solid target or target liquid) is provided to a designated production chamber 120 of the target system assembly 140. The target material 116 may be provided to the production chamber 120 through the fluidic-control system 125. The fluidic-control system 125 may include an interconnected network of one or more valves (e.g., solenoid valve, check valve, hand valve, injection valve, pressure regulator, and the like), one or more pumps (e.g., syringe pumps, compressed air pumps, vacuum pumps, and the like), one or more controllers (e.g., mass flow controller), a plurality of fluidic lines (e.g., flexible tubing, passages through sections of the target housing, and the like), one or more filters, and a plurality of vessels (e.g., storage vessels, waste vessels, vials, solution traps). Moreover, the fluidic-control system may include a plurality of sensors, detectors, or transducers (e.g., pressure sensor, current detector, voltage detector, flow sensor, temperature sensor) that may monitor operation of the fluidic-control system and communicate with a control system 118. In FIG. 1, the pumps and valves are referred to collectively at 144 and are configured to control a flow of fluid through the target assembly 140. It should be understood that the pumps and the valves may be positioned at various locations within the fluidic-control system 125. For example, a syringe pump may be positioned upstream or downstream from a production chamber 120. It should also be understood that pumps may control a flow of fluid within the fluidic-control system 125 by applying a negative pressure and/or a positive pressure to the fluidic lines, production chamber, etc.

Fluids may include, for example, one or more electrolytic solutions, one or more gases, and one or more product solutions. An electrolytic solution includes designated metal ions that will be used to deposit or plate a solid target onto a conductive base or backing. A product solution includes dissolved target material after the target material has been irradiated by the particle beam 112. As shown, the fluidic-control system 125 also includes a storage vessel 146 and a storage vessel 148. The storage vessel 146 is configured to hold the electrolytic solution. The storage vessel 148 is configured to receive a product solution.

The fluidic-control system 125 may control flow of the electrolytic solution through the one or more pumps and valves 144 to the production chamber 120. The fluidic-control system 125 may also control a pressure that is experienced within the production chamber 120 by providing an inert gas into the production chamber 120. During operation of the particle accelerator 102, charged particles are placed within or injected into the particle accelerator 102 through the ion source system 104. The magnetic field system 108 and electrical field system 106 generate respective fields that cooperate with one another in producing the particle beam 112 of the charged particles.

The isotope production system 100 also has an extraction system 115. The target system 114 may be positioned adjacent to the particle accelerator 102. To generate isotopes, the particle beam 112 is directed by the particle accelerator 102 through the extraction system 115 along a beam transport path or beam passage 117 and into the target system 114 so that the particle beam 112 is incident upon the target material 116 located at the designated production chamber 120. It should be noted that in some embodiments the particle accelerator 102 and target system 114 are not separated by a space or gap (e.g., separated by a distance) and/or are not separate parts. Accordingly, in these embodiments, the particle accelerator 102 and target system 114 may form a single component or part such that the beam passage 117 between components or parts is not provided.

The isotope production system 100 is configured to produce radioisotopes (also called radionuclides or radiopharmaceuticals) that may be used in medical imaging, research, and therapy, but also for other applications that are not medically related, such as scientific research or analysis. When used for medical purposes, such as in Nuclear Medicine (NM) imaging or Positron Emission Tomography (PET) imaging, the radioisotopes may also be called tracers. The isotope production system 100 may produce the isotopes in predetermined amounts or batches, such as individual doses for use in medical imaging or therapy. By way of example, the isotope production system 100 may generate isotopes after irradiating a solid target. Alternatively, the isotope production system 100 may generate ⁶⁸Ga isotopes from a target liquid comprising ⁶⁸Zn nitrate in nitric acid. The isotope production system 100 may also be configured to generate protons to make ¹⁸F⁻ isotopes in liquid form. The target material used to make these isotopes may be enriched ¹⁸O water or ¹⁶O-water. In some embodiments, the isotope production system 100 may also generate protons or deuterons in order to produce ¹⁵O labeled water. Isotopes having different levels of activity may be provided.

In some embodiments, the isotope production system 100 uses ¹H⁻ technology and brings the charged particles to a low energy (e.g., about 8 MeV) with a beam current of approximately 10-30 μA. In such embodiments, the negative hydrogen ions are accelerated and guided through the particle accelerator 102 and into the extraction system 115. The negative hydrogen ions may then hit a stripping foil (not shown in FIG. 1) of the extraction system 115 thereby removing the pair of electrons and making the particle a positive ion, ¹H⁺. However, in alternative embodiments, the charged particles may be positive ions, such as ¹H⁺, ²H⁺, and ³He⁺. In such alternative embodiments, the extraction system 115 may include an electrostatic deflector that creates an electric field that guides the particle beam toward the target material 116. It should be noted that the various embodiments are not limited to use in lower energy systems, but may be used in higher energy systems, for example, up to 25 MeV and higher beam currents.

The isotope production system 100 may include a cooling system 122 that transports a cooling fluid (e.g., water or gas, such as helium) to various components of the different systems in order to absorb heat generated by the respective components. For example, one or more cooling channels may extend proximate to the production chambers 120 and absorb thermal energy therefrom. The isotope production system 100 may also include a control system 118 that may be used to control the operation of the various systems and components. The control system 118 may include the necessary circuitry for automatically controlling the isotope production system 100 and/or allowing manual control of certain functions. For example, the control system 118 may include one or more processors or other logic-based circuitry and a storage medium that is configured to store programmed instructions accessible by the one or more processors. The control system 118 may be configured to automate at least some of the steps or operations described herein, such as the steps or operations for generating a solid target within a production chamber and/or directing a particle beam onto the solid target. In some embodiments, however, one or more of these steps or operations are not automated, but may be performed manually (e.g., by a technician). For instance, the isotope production system 100 may enable an individual to open or close valves and activate one or more pumps to induce the flow of a solution in order to generate the solid target or to dissolve the irradiated target.

The control system 118 may include one or more user-interfaces that are located proximate to or remotely from the particle accelerator 102 and the target system 114. Although not shown in FIG. 1, the isotope production system 100 may also include one or more radiation and/or magnetic shields for the particle accelerator 102 and the target sy stem 114.

The isotope production system 100 may be configured to accelerate the charged particles to a predetermined energy level. For example, embodiments described herein accelerate the charged particles to an energy of approximately 18 MeV or less. In other embodiments, the isotope production system 100 accelerates the charged particles to an energy of approximately 16.5 MeV or less. In particular embodiments, the isotope production system 100 accelerates the charged particles to an energy of approximately 9.6 MeV or less. In more particular embodiments, the isotope production system 100 accelerates the charged particles to an energy of approximately 7.8 MeV or less. However, embodiments describe herein may also have an energy above 18 MeV. For example, embodiments may have an energy above 100 MeV, 500 MeV or more. Likewise, embodiments may utilize various beam current values. By way of example, the beam current may be between about of approximately 10-30 μA. In other embodiments, the beam current may be above 30 μA, above 50 μA, or above 70 μA. Yet in other embodiments, the beam current may be above 100 μA, above 150 μA, or above 200 μA.

The isotope production system 100 may have multiple production chambers 120A-C where separate target materials 116A-C are located. A shifting device or system (not shown) may be used to shift the production chambers 120A-C with respect to the particle beam 112 so that the particle beam 112 is incident upon a different target material 116. A vacuum may be maintained during the shifting process as well. Alternatively, the particle accelerator 102 and the extraction system 115 may not direct the particle beam 112 along only one path, but may direct the particle beam 112 along a unique path for each different production chamber 120A-120C. Furthermore, the beam passage 117 may be substantially linear from the particle accelerator 102 to the production chamber 120 or, alternatively, the beam passage 117 may curve or turn at one or more points therealong. For example, magnets positioned alongside the beam passage 117 may be configured to redirect the particle beam 112 along a different path.

To execute the electroplating process, an electrolytic solution is directed into the production chamber 120. As described herein, the target assembly 140 includes an electrode and a conductive base or backing exposed to the electrolytic solution. Collectively, the production chamber, the electrolytic solution, the electrode, and the conductive base form an electrolytic cell. A power source 127 is electrically connected to the electrode and the conductive base. The power source 127 is configured to apply a voltage between the electrode and the conductive base, thereby causing the metal ions in the electrolytic solution to form a layer along the conductive base.

The electrolytic solution may include, for example, a soluble inorganic salt (e.g., chloride, sulphate, perchlorate), an acid (e.g., nitric, sulphuric, hydrochloric or perchloric acid) or a base (e.g., sodium hydroxide, ammonia). Optionally, additives may be used to improve deposition of the metal. Such additives may include reagents, surfactants, cathodic or anodic depolarizers, and stress-reducing agents.

Various parameters may be controlled in order to obtain the desired solid target. Such parameters include the applied voltage (e.g., fixed or varying), current density, temperature of the solution, and composition of the electrolytic solution (e.g., metal concentration, pH, and optional complexing agents, surfactants, depolarizers, and stress reducing agents). Other parameters may include the surface areas of the electrode and conductive base (or the anode and cathode).

A power source (e.g., battery, rectifier, and the like) may control the voltage and/or the current in order to obtain the desired solid target. For example, the power source may be controlled to provide a constant voltage or a constant current or a waveform that varies the voltage and/or current. Constant voltage may enable varying the plating current or current density as a function of time. In constant current electrolysis, a designated current is set through the electrolytic cell and the voltage may be adjusted (e.g., increased over time) so that the designated current is maintained within the electrolytic cell. In some embodiments, the current may be pulsed or have a varying amplitude.

In some embodiments, the electrolytic solution is moved during the electroplating process. The movement of the electrolytic solution may reduce the likelihood that the metal ions will become more concentrated in certain regions during the electroplating process so that the solid target may be more uniformly deposited. Movement may be accomplished using one or more mechanism. As one example, embodiments may include stirring or vibrating devices 126 (referenced as 126A, 126B, 126C) that are configured to cause vibrations in the target body 142 thereby moving the electrolytic solution within the production chamber. Each device 126 may also be referred to as a vibrator or shaker. As shown the devices 126 are coupled to an exterior of the target body 142. However, the devices 126 may be deposited within an interior of the target body 142. In some embodiments, the devices 126 may be controlled by the control system 118. For example, the control system 118 may activate the devices 126 during the electroplating process.

Alternatively or in addition to the above, the fluidic-control system 125 may be configured to move the electrolytic solution through production chamber 120 during the electroplating process. For example, the production chamber 120 may be accessible through two more fluidic ports. The fluidic-control system 125 may repeatedly move the electrolytic solution back and forth within the production chamber 120 during the electroplating process. For instance, when a positive pressure is applied, the solution may flow into the production chamber 120 through a first port and out of the production chamber 120 through a second port and, when a negative pressure is applied, the solution may flow into the production chamber 120 through the second port and out of the production chamber 120 through the first port.

Alternatively or in addition to the above, the target assembly 140 may be agitated during the electroplating process. In such embodiments, the target assembly 140 may be disconnected with respect to the remainder of the system 100 during the electroplating process and the connected after the electroplating process.

As another example, the devices 126 may be deposited within the production chamber during the electroplating process. In such embodiments, the devices 126 may be referred to as stirrers. One or more devices 126 may flow into the production chamber 120 with the electrolytic solution. The devices 126 may be in constant motion within the electrolytic solution or may be activated at a designed time (e.g., by the current flowing through the solution). During the electroplating process, the device 126 move (e.g., stir) the electrolytic solution. After the electroplating process, the device 126 may flow out of the production chamber with the electrolytic solution.

Examples of isotope production systems and/or cyclotrons having one or more of the sub-systems described herein may be found in U.S. Patent Application Publication No. 2011/0255646, which is incorporated herein by reference in its entirety. Furthermore, isotope production systems and/or cyclotrons that may be used with embodiments described herein are also described in U.S. patent application Ser. Nos. 12/492,200; 12/435,903; 12/435,949; 12/435,931 and U.S. patent application Ser. No. 14/754,878 (having Attorney Docket No. 281969 (553-1948)), each of which is incorporated herein by reference in its entirety. The vibrating devices (or vibrators or shakers) described herein may be similar to the electromechanical motors described in U.S. Pat. No. 8,653,762, which is incorporated herein by reference in its entirety.

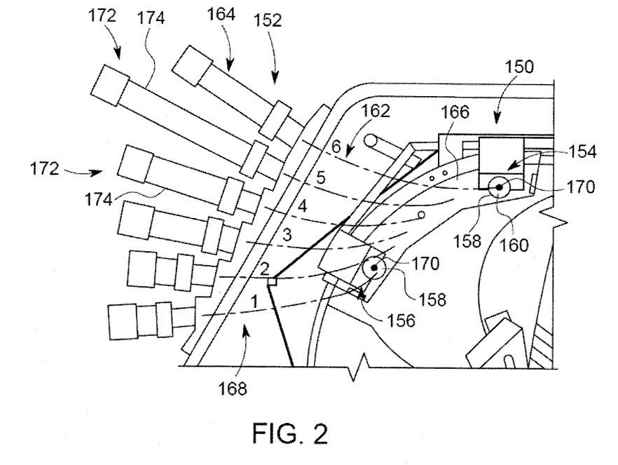

FIG. 2 is a side view of an extraction system 150 and a target system 152 that may be used with an isotope production system and a particle accelerator, such as the system 100 (FIG. 1) or the particle accelerator 102 (FIG. 1). The target system 152 may replace the target system 114 (FIG. 1). In the illustrated embodiment, the extraction system 150 includes first and second extraction units 154, 156 that each includes a foil holder 158 and one or more extraction foils 160 (also referred to as stripper foils). The extraction process may be based on a stripping-foil principle. More specifically, the electrons of the charged particles (e.g., the accelerated negative ions) are stripped as the charged particles pass through the extraction foil 160. The charge of the particles is changed from a negative charge to a positive charge thereby changing the trajectory of the particles in the magnet field. The extraction foils 160 may be positioned to control a trajectory of an external particle beam 162 that includes the positively-charged particles and may be used to steer the external particle beam 162 toward designated target locations 164.

In the illustrated embodiment, the foil holders 158 are rotatable carousels that are capable of holding one or more extraction foils 160. However, the foil holders 158 are not required to be rotatable. The foil holders 158 may be selectively positioned along a track or rail 166. The extraction system 150 may have one or more extraction modes. For example, the extraction system 150 may be configured for single-beam extraction in which only one external particle beam 162 is guided to an exit port 168. In FIG. 2, there are six exit ports 168, which are enumerated as 1-6.

The extraction system 150 may also be configured for dual-beam extraction in which two external beams 162 are guided simultaneously to two exit ports 168. In a dual-beam mode, the extraction system 150 may selectively position the extraction units 156, 158 such that each extraction unit intercepts a portion of the particle beam (e.g., top half and bottom half). The extraction units 156, 158 are configured to move along the track 166 between different positions. For example, a drive motor may be used to selectively position the extraction units 156, 158 along the track 166. Each extraction unit 156, 158 has an operating range that covers one or more of the exit ports 168. For example, the extraction unit 156 may be assigned to the exit ports 4, 5, and 6, and the extraction unit 158 may be assigned to the exit ports 1, 2, and 3. Each extraction unit may be used to direct the particle beam into the assigned exit ports.

The foil holders 158 may be insulated to allow for current measurement of the stripped-off electrons. The extraction foils 160 are located at a radius of the beam path where the beam has reached a final energy. In the illustrated embodiment, each of the foil holders 158 holds a plurality of extraction foils 160 (e.g., six foils) and is rotatable about an axis 170 to enable positioning different extraction foils 160 within the beam path.

The target system 152 includes a plurality of target assemblies 172. A total of six target assemblies 172 are shown and each corresponds to a respective exit port 168. When the particle beam 162 has passed the selected extraction foil 160, it will pass into the corresponding target assembly 172 through the respective exit port 168. The particle beam enters a target chamber (not shown) of a corresponding target body 174. The target chamber holds the target material (e.g., liquid, gas, or solid material) and the particle beam is incident upon the target material within the target chamber. The particle beam may first be incident upon one or more target sheets within the target body 174, as described in greater detail below. The target assemblies 172 are electrically insulated to enable detecting a current of the particle beam when incident on the target material, the target body 174, and/or the target sheets or other foils within the target body 174.

Examples of isotope production systems and/or cyclotrons having one or more of the sub-systems described herein may be found in U.S. Patent Application Publication No. 2011/0255646, which is incorporated herein by reference in its entirety. Furthermore, isotope production systems and/or cyclotrons that may be used with embodiments described herein are also described in U.S. patent application Ser. Nos. 12/492,200; 12/435,903; 12/435,949; 12/435,931 and U.S. patent application Ser. No. 14/754,878, each of which is incorporated herein by reference in its entirety.

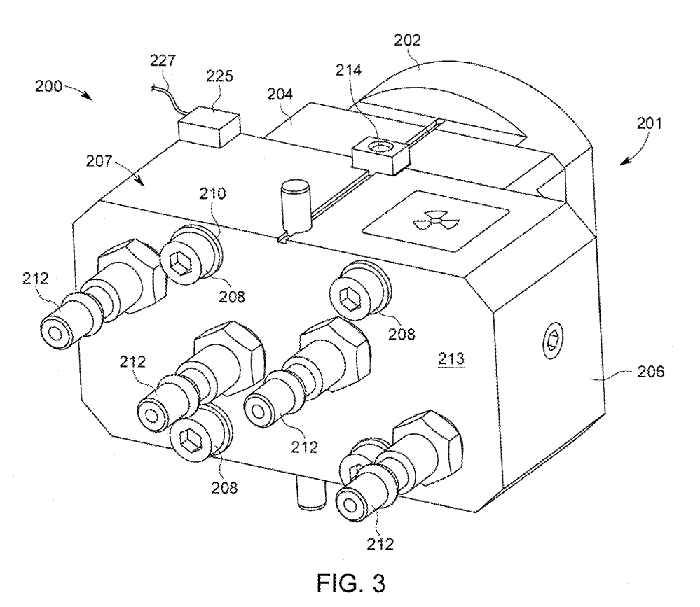

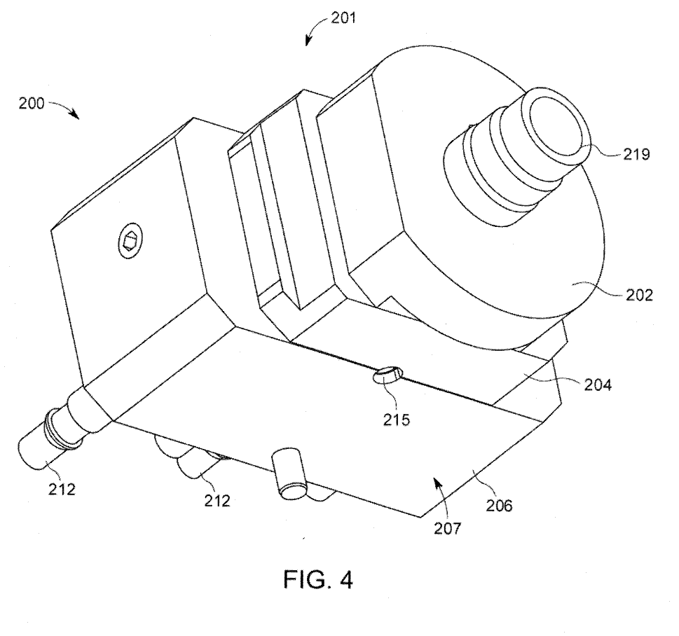

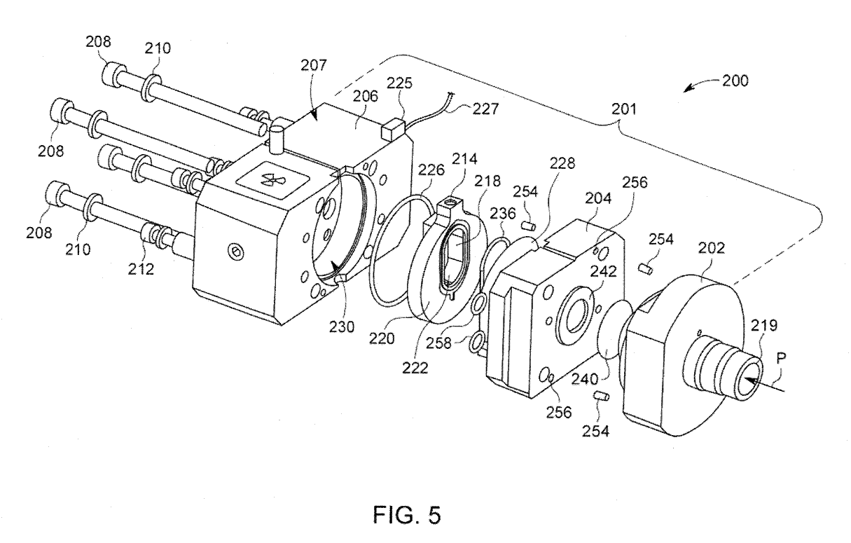

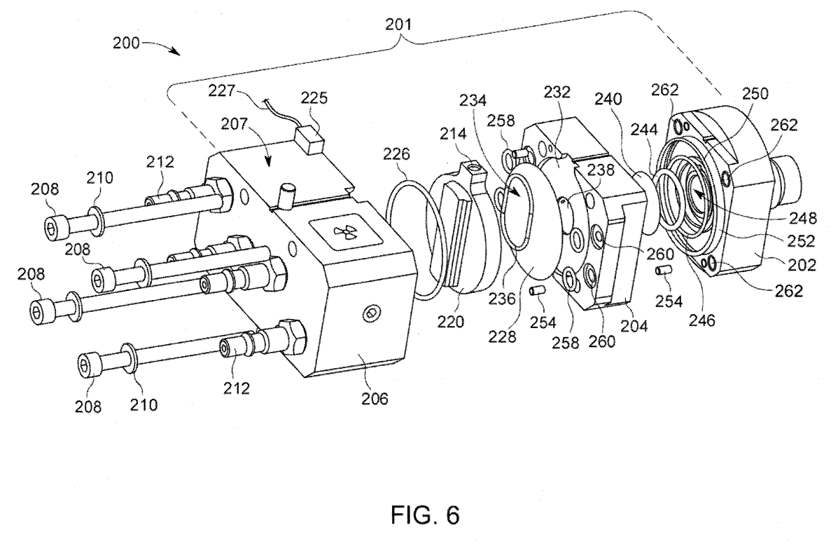

FIGS. 3 and 4 are rear and front perspective views, respectively, of a target assembly 200 formed in accordance with an embodiment. FIGS. 5 and 6 are exploded views of the target assembly 200. The target assembly 200 is configured to receive and hold a solution (e.g., electrolytic solution or dissolving solution). The target assembly 200 may also be configured to hold a liquid target material in other embodiments during irradiation. In other embodiments, however, the target assembly 200 may be configured to an electrolytic solution during an electroplating process and hold a solid target during isotope production.

The target assembly 200 includes a target body 201 and a stirring or vibrating device 225 (shown in FIGS. 3, 5, and 6) that is configured to be attached to the target body 201. The target body 201 is fully assembled in FIGS. 3 and 4 The target body 201 is formed from three body sections 202, 204, 206 and a target insert 220 (FIGS. 5 and 6). The body sections 202, 204, 206 define an outer structure of the target body 201. In particular, the outer structure of the target body 201 is formed from a body section 202 (which may be referred to as a front body section or flange), a body section 204 (which may be referred to as an intermediate body section) and a body section 206 (which may be referred to as a rear body section). The body sections 202, 204 and 206 include blocks of rigid material having channels and recesses to form various features. The channels and recesses may hold one or more components of the target assembly 200. The body sections 202, 204, and 206 may be secured to one another by suitable fasteners, illustrated as a plurality of bolts 208 (FIGS. 3, 5, and 6) each having a corresponding washer 210. When secured to one another, the body sections 202, 204 and 206 form a sealed target body 201.

In some embodiments, the target body 201 may form part of an electrolytic cell that includes an anode and cathode separated from one another. Such embodiments may be similar to the target body 302 below. To this end, a portion (or sub-section) of the body section 204 and/or a portion (or sub-section) of the target insert 220 may comprise an insulative material. As such, the insulative portion or sub-section may separate the anode and cathode of the electrolytic cell. Alternatively, a discrete insulative body section (not shown) may be added to the target body 201. For example, the insulative body section may be positioned between the target insert 220 and the body section 204.

Also shown, the target assembly 200 includes a plurality of fittings 212 that are positioned along a rear surface 213. The fittings 212 may operate as ports that provide fluidic access into the target body 201. The fittings 212 are configured to be operatively coupled to a fluidic-control system, such as the fluidic-control system 125 (FIG. 1). The fittings 212 may provide fluidic access for helium and/or cooling water. In addition to the ports formed by the fittings 212, the target assembly 200 may include a fluidic port 214 and a second fluidic port 215. The first and second fluidic ports 214, 215 are in flow communication with a production chamber 218 (FIG. 5) of the target assembly 200. The first and second fluidic ports 214, 215 are operatively coupled to a fluidic-control system.

In an exemplary embodiment, the second fluidic port 215 may provide an electrolytic solution and, separately, a dissolving solution to the production chamber 218, and the first fluidic port 214 may provide a working gas (e.g., inert gas) for controlling the pressure experienced by the solutions within the production chamber 218 and/or moving the solutions within the production chamber 218 and throughout the isotope production system. In other embodiments, however, the first fluidic port 214 may provide the target material and the second fluidic port 215 may provide the working gas. It should be understood that the first and second fluidic ports 214, 215 may have other locations in different embodiments. Moreover, embodiments may include additional fluidic ports.

The target body 201 forms a beam passage or cavity 221 that permits a particle beam (e.g., proton beam) to be incident on the target material within the production chamber 218. The particle beam (indicated by arrow P in FIG. 5) may enter the target body 201 through a passage opening 219 (FIGS. 4 and 5). The particle beam travels through the target assembly 200 from the passage opening 219 to the production chamber 218 (FIG. 5). During operation, the production chamber 218 is filled with a liquid, for example, with about 2.5 milliliters (ml) of a solution. The production chamber 218 is defined within the target insert 220 that may comprise, for example, a niobium material having a cavity 222 (FIG. 5) that opens on one side of the target insert 220. The target insert 220 includes the first and second material ports 214, 215. The first and second material ports 214, 215 are configured to receive, for example, fittings or nozzles.

With respect to FIGS. 5 and 6, the target insert 220 is aligned between the body section 206 and the body section 204. The target assembly 200 may include a sealing ring 226 that is positioned between the body section 206 and the target insert 220. The target assembly 200 also includes a foil member 228 and a sealing border 236 (e.g., a Helicoflex® border). The foil member 228 may comprise a metal alloy disc comprising, for example, a heat-treatable cobalt base alloy, such as Havar®. The foil member 228 is positioned between the body section 204 and the target insert 220 and covers the cavity 222 thereby enclosing the production chamber 218. The body section 206 also includes a cavity 230 (FIG. 5) that is shaped and sized to receive therein the sealing ring 226 and a portion of the target insert 220. Additionally, the body section 206 includes a cavity 232 (FIG. 5) that is sized and shaped to receive therein a portion of the foil member 228. The foil member 228 is also aligned with an opening 238 (FIG. 6) to a passage through the body section 204.

Optionally, a foil member 240 may be provided between the body section 204 and the body section 202. The foil member 240 may be an alloy disc similar to the foil member 228. The foil member 240 aligns with the opening 238 of the body section 204 having an annular rim 242 (FIG. 5) therearound. As shown in FIG. 5, a seal 244, a sealing ring 246, and a sealing ring 250 are concentrically aligned with an opening 248 of the body section 202 and couple onto a rim 252 of the body section 202. The seal 244, the sealing ring 246, and the sealing ring 250 are provided between the foil member 240 and the body section 202. It should be noted more or fewer foil members may be provided. For example, in some embodiments only the foil member 228 is included. Accordingly, a single foil member or multi-foil member arrangements are contemplated by the various embodiments.

It should be noted that the foil members 228 and 240 are not limited to a disc or circular shape and may be provided in different shapes, configurations and arrangements. For example, the one or more the foil members 228 and 240, or additional foil members, may be square shaped, rectangular shaped, or oval shaped, among others. Also, it should be noted that the foil members 228 and 240 are not limited to being formed from a particular material, but in various embodiments are formed from a an activating material, such as a moderately or high activating material that can have radioactivity induced therein as described in more detail herein. In some embodiments, the foil members 228 and 240 are metallic and formed from one or more metals.

As shown in FIGS. 5 and 6, a plurality of pins 254 are received within openings 256 in each of the body sections 202, 204 and 206 to align these component when the target assembly 200 is assembled. Additionally, a plurality of sealing rings 258 align with openings 260 of the body section 204 for receiving therethrough the bolts 208 that secure within bores 262 (e.g., threaded bores) of the body section 202.

During operation, as the particle beam passes through the target assembly 200 from the body section 202 into the production chamber 218, the foil members 228 and 240 may be heavily activated (e.g., radioactivity induced therein). The foil members 228 and 240, which may be, for example, thin (e.g., 5-50 micrometer or micron (μm)) foil alloy discs, isolate the vacuum inside the accelerator, and in particular the accelerator chamber and from the liquid in the cavity 222. The foil members 228 and 240 also allow cooling helium to pass therethrough and/or between the foil members 228 and 240. It should be noted that the foil members 228 and 240 are configured to have a thickness that allows a particle beam to pass therethrough. Consequently, the foil members 228 and 240 may become highly radiated and activated.

Some embodiments provide self-shielding of the target assembly 200 that actively shields the target assembly 200 to shield and/or prevent radiation from the activated foil members 228 and 240 from leaving the target assembly 200. Thus, the foil members 228 and 240 are encapsulated by an active radiation shield. Specifically, at least one of, and in some embodiments, all of the body sections 202, 204 and 206 are formed from a material that attenuates the radiation within the target assembly 200, and in particular, from the foil members 228 and 240. It should be noted that the body sections 202, 204 and 206 may be formed from the same materials, different materials or different quantities or combinations of the same or different materials. For example, body sections 202 and 204 may be formed from the same material, such as aluminum, and the body section 206 may be formed from a combination or aluminum and tungsten.

The body section 202, body section 204 and/or body section 206 are formed such that a thickness of each, particularly between the foil members 228 and 240 and the outside of the target assembly 200 provides shielding to reduce radiation emitted therefrom. It should be noted that the body section 202, body section 204 and/or body section 206 may be formed from any material having a density value greater than that of aluminum. Also, each of the body section 202, body section 204 and/or body section 206 may be formed from different materials or combinations or materials as described in more detail herein.

The stirring or vibrating device 225 is configured to be secured to at least one of the body sections. As used herein, when a stirring or vibrating device is “secured to” a component, the stirring or vibrating device is attached to the component in a manner that is sufficient for transferring vibrations into the component. The stirring or vibrating device may be secured by one or more elements. For example, the stirring or vibrating device may include a housing that is secured to the target body through hardware (e.g., screws or bolts). Alternatively or in addition to the hardware, the stirring or vibrating device may be secured to the target body through other types of fasteners (e.g., latches, clasps, belts, and the like) and/or an adhesive. By way of example, a target body, such as the target body 201, may include first and second body sections that are secured to each other and have fixed positions relative to each other. A production chamber may be defined by at least one of the first body section or the second body section. The stirring or vibrating device may be secured to at least one of the first body section or the second body section.

As shown in FIGS. 3, 5, and 6, the stirring or vibrating device 225 is secured to the body section 206. In other embodiments, however, the stirring or vibrating device 225 may be secured to the body section 204, the body section 202, or the target insert 220. In other embodiments, the stirring or vibrating device 225 may be simultaneously secured to more than one body section. For example, if the exterior surfaces of two body sections are flush or even, the stirring or vibrating device 225 may extend across the interface between the two body sections.

In the illustrated embodiment, the stirring or vibrating device 225 is secured to an outer or exterior surface 207 of the body section 206. In other embodiments, the stirring or vibrating device 225 may be positioned within a recess, cavity, or chamber of the target assembly 200. In the illustrated embodiment, the stirring or vibrating device 225 is electrically connected to a control system (not shown), such as the control system 118 (FIG. 1), through one or more wires 227 so that the control system may control operation of and/or supply power to the stirring or vibrating device 225. It is contemplated, however, that the vibrating device 225 may be wirelessly controlled and/or receive power through wireless transfer power.

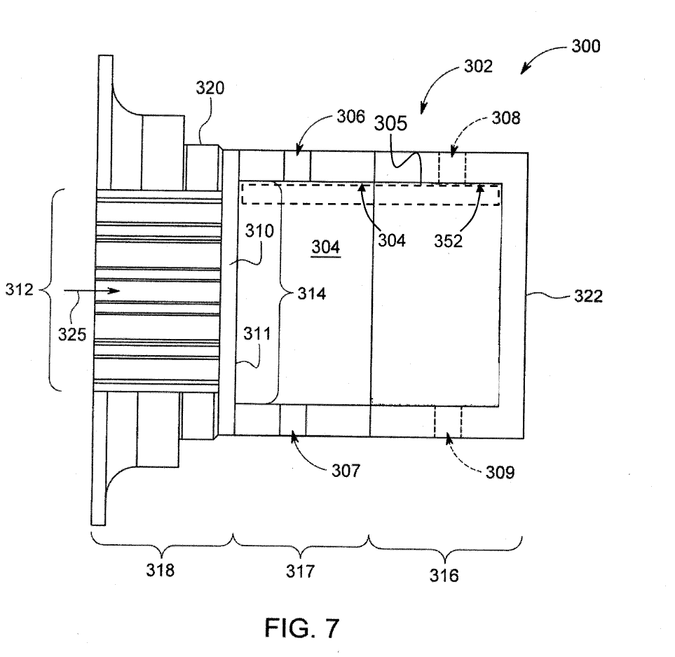

FIG. 7 is a cross-section of at least a portion of a target assembly 300 formed in accordance with an embodiment. The target assembly 300 may include additional components that are not shown, such as those described with respect to the target assembly 200 (FIG. 3). The target assembly 300 includes a target body 302 that defines a production chamber 304. The target body 302 also includes fluidic ports 306, 307. Optionally, the target body 302 may include additional ports, such as fluidic ports 308, 309. The fluidic ports 306-309 provide fluidic access to the production chamber 304 such that fluid (e.g., gas or liquid) may be directed into and out of the production chamber 304. The flow may be controlled by a fluidic-control system, such as the fluidic-control system 125 (FIG. 1). In the illustrated embodiment, the fluidic ports 306-309 are positioned such that a single cross-sectional plane intersects each of the fluidic ports 306-309. In other embodiments, the fluidic ports 306-309 may have different positions with respect to one another and the target body 302.

In some embodiments, the fluidic ports 306-309 may have designated functions. For example, the fluidic port 306, 308 may always be inlet ports that receive fluid, and the fluidic ports 307, 309 may always be outlet ports through which the fluid exits. In other embodiments, one or more of the fluidic ports 306-309 may allow the fluid to flow therethrough in either direction.

In some embodiments, one or more of the fluidic ports 306-309 may be configured to allow the removal of gases, such as H₂ and O₂, that are generated during the electroplating process (or electrolysis). Removing gases from the production chamber 304 may be referred to as venting. For example, the fluidic ports configured for venting may be located adjacent to a gas-accumulating region of the production chamber where the gases may accumulate. With reference to FIG. 7, the gases may migrate upward into a gas-accumulating region 305 that is adjacent to the fluidic ports 306 and 308. At least one of the fluidic ports 306, 308 may be in flow communication with a pump that is configured to draw the gases from the gas-accumulating region 305 and out of the production chamber 304. Optionally, interior surfaces 350, 352 of the target body 302 may be shaped to direct the gases toward the fluidic port(s) configured for venting and/or provide space to allow the gases to accumulate within the production chamber 304 without causing unwanted effects to the electroplating process.

The target assembly 300 also includes a target foil or sheet 310. The target foil 310 may be aligned with and/or disposed in a beam passage 312. A particle beam 325 (arrow shown for reference) is configured to be incident upon the target foil 310. The target foil 310 may also cover an opening 314 to the production chamber 304. As such, the production chamber 304 may be a void that is essentially defined by the interior surfaces 350, 352 of the target body 302 and an inner surface 311 of the target foil 310.

The target body 302 may include a plurality of body sections that are secured to one another. For example, the target body 302 may include a rear body section 316, an intermediate body section 317, and a front body section 318. The front body section 318 may also be referred to as a front flange. In some embodiments, the rear body section 316 and the front body section 318 comprise a metal material, such as aluminum, copper, tungsten, niobium, tantalum, or an alloy that includes a combination of one or more of the above or other materials. In some embodiments, the intermediate body section 317 comprises an insulative material. More specifically, the insulative material is designed to electrically separate an electrode and a conductive base within the production chamber 304 so that an electroplating process may be carried out. Moreover, the insulative material is designed to withstand the heat generated during isotope production. By way of example, the insulative material may include a high-performance thermoplastic (e.g., polyether ether ketone (PEEK), polyether ketones (PEK)) or a ceramic material. Based upon the insulative material used, the intermediate body section 317 may or may not include the fluidic ports 306, 307.

The target assembly 300 also includes an electrode 320 and a conductive base 322 that are exposed to the production chamber 304. For example, the interior surface 352 of the conductive base 322 partially defines the production chamber 304 and the inner surface 311 of the target foil 310 partially defines the production chamber 304. In the illustrated embodiment, the electrode 320 is formed by the target foil 310 and the front body section 318 of the target body 302. The conductive base 322 is formed by the rear body section 316. The production chamber 304, the electrode 320, and the conductive base 322 form an electrolytic cell 335 when an electrolytic solution is disposed in the production chamber 304. During an electroplating process, the electrode 320 may function as an anode and the conductive base 322 may function as a cathode. The conductive base 322 (or the rear body section 316) has the interior surface 352 that defines a portion of the production chamber 304. The electrode 320 and the conductive base 322 may also be referred to as first and second electrodes, respectively, or as anode and cathode, respectively. The intermediate body section 317 includes the interior surface 350.

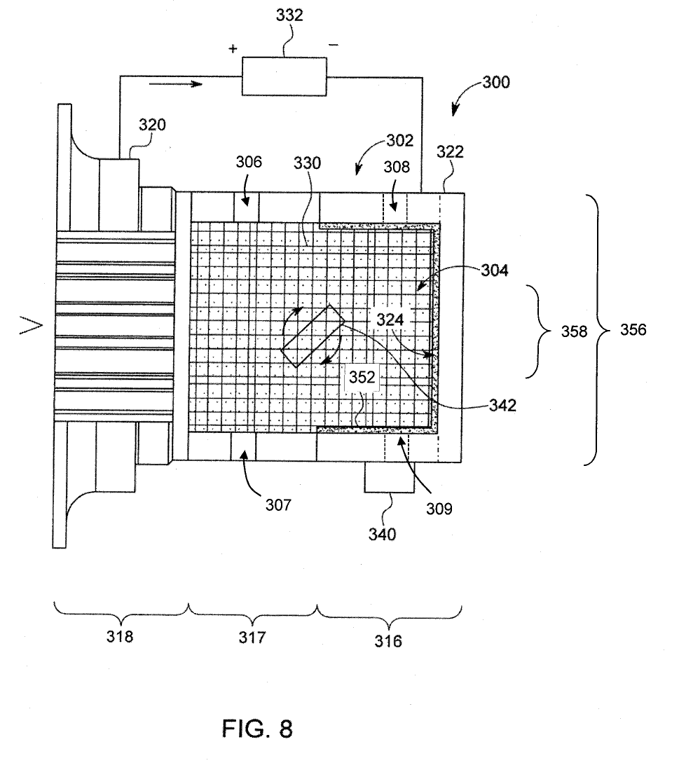

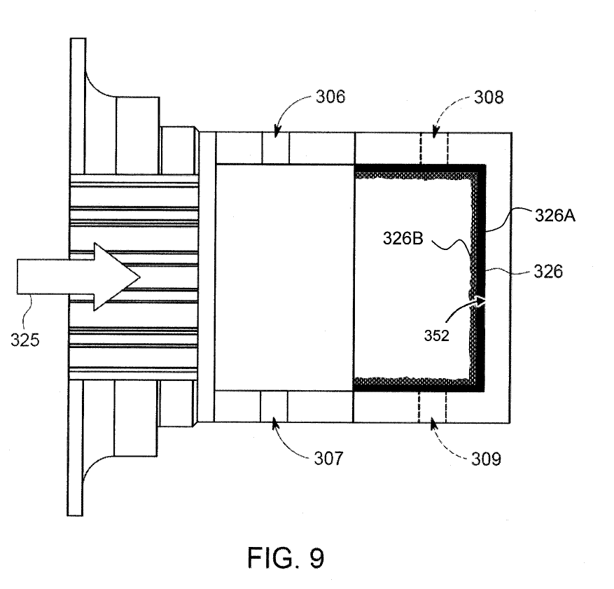

FIG. 8 is a cross-section of the target assembly 300 after an electrolytic solution 330 has filled the production chamber 304. The electrolytic solution 330 may be directed into the production chamber 304 by a fluidic-control system. As shown, a power source (e.g., power supply, such as a battery or rectifier) 332 is electrically connected to the electrode 320 and the conductive base 322. While the power source 332 applies a voltage between the electrode 320 and the conductive base 322, metal ions within the electrolytic solution 330 are deposited along the interior surface 352 and form or develop a solid target (or target layer) 326. After a time period, the solid target 326 may have a sufficient thickness for isotope production. The electroplating process may end after a set time period or after determining that a designated condition or conditions have been satisfied (e.g., detected voltage). Although the above describes the development of a solid target having a single layer, it should be understood that multiple electroplating processes may be performed to generate multiple layers. For example, with respect to FIG. 9, the solid target 326 may include a first sub-layer 326A (e.g., copper) that is directly bonded to the interior surface 352 and a second sub-layer 326B that is bonded to the first sub-layer 326A and constitutes the target material that will be irradiated.

Alternatively or in addition to the above, the solid target 326 may be deposited along the inner surface 311 of the target foil 310. As such, embodiments may have the solid target 326 positioned along the interior surface 352, the inner surface 311, or both the interior surface 352 and the inner surface 311. For embodiments in which the solid target is located along both the interior surface 352 and the inner surface 311, an optional third electrode may be used. For example, the target body may include one or more additional body sections in which one of these additional body sections functions as another electrode.

Optionally, the electrolytic solution 330 may be moved (e.g., stirred, agitated, pumped, and the like) to reduce the likelihood that gradients of the metal ions (e.g., regions with greater concentration) develop, which may be undesirable as the solid target 326 is generated. As described above, one or more mechanism may be used to move the electrolytic solution during the electroplating process. For example, a vibrating device 340 may be secured to the target body 302 and configured to cause vibrations in the target body 302 thereby moving the electrolytic solution within the production chamber 304. As shown, the device 340 is secured to an exterior of the target body 302. However, the device 340 may be deposited within a recess of the target body 302.

Alternatively or in addition to the above, the fluidic-control system 125 may be configured to move the electrolytic solution through the production chamber 304 during the electroplating process. For example, a fluidic-control system may provide varying amounts of pressure to the electrolytic solution 330 such that the electrolytic solution moves through the ports 306-309. A combination of changing pressures may be used to cause a desired movement within the production chamber 304. Alternatively or in addition to the above, the target body 302 may be agitated during the electroplating process.

As another example, one or more stirring devices 342 may be deposited within the production chamber 304 during the electroplating process. In such embodiments, one or more stirring devices 342 may flow into the production chamber 304 with the electrolytic solution 330. The stirring device 342 may be in constant motion within the electrolytic solution 330 or may be activated at a designed time (e.g., by the current flowing through the solution). During the electroplating process, the stirring device 342 moves (e.g., stir) the electrolytic solution 330. After the electroplating process, the stirring device 342 may flow out of the production chamber with the electrolytic solution 330.

In FIG. 8, the rear body section 316 surrounds and defines a portion of the volume of the production chamber 304 and the intermediate body section 317 surrounds and defines a portion of the volume of the production chamber 304. Optionally, the size and shapes of the body sections 316, 317, and 318 may be selected to achieve a desired performance. For example, the size and shapes of the body sections 316, 317, and 318 may be selected to provide a desired amount of surface area for the electrode 320 and a desired amount of surface area for the conductive base 322. More specifically, the conductive base 322 may be shaped to provide a cover 356 that defines the entire rear wall (and only the rear wall) of the target body 301. As another example, the conductive base 322 may be shaped to provide a cap 358 that defines only a portion of the rear wall of the target body 301. In either example, the intermediate body section 317 and the front body section 316 may be shaped to complete the target body 302. In such instances, a designated ratio of the surface areas of the electrode 320 (or anode) and the conductive base 322 (or cathode) may be obtained. Moreover, the surface area upon which the solid target 326 is deposited may be more clearly defined or localized. As shown, the cover 356 and the cap 358 are oriented perpendicular to the particle beam 325. Optionally, the cover 356 and the cap 358 may be oriented at a non-perpendicular angle with respect to the particle beam 325.

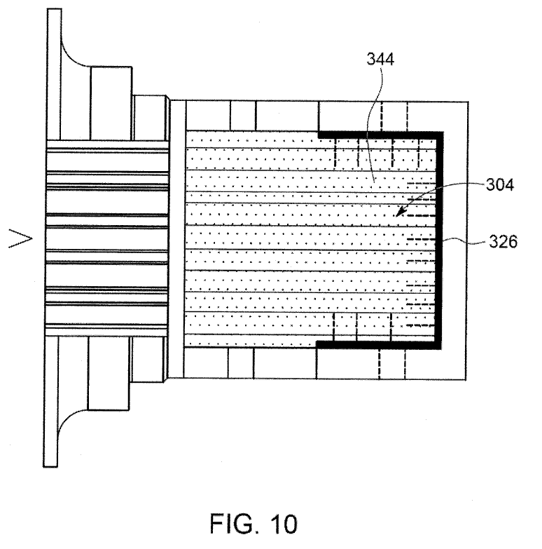

FIGS. 9 and 10 illustrate a cross-section of the target assembly during irradiation with the particle beam 325 and dissolving of the solid target 326. Prior to irradiation, a gas (e.g., helium or argon) may be directed through two or more of the ports 306-309 to aspirate or otherwise dry out the electrolytic solution. The production chamber 304 may also be evacuated (e.g., by a pump) to remove a substantial amount of gas prior to irradiation. After irradiation (as shown in FIG. 10), a dissolving solution 344 may be directed into the production chamber 304 by the fluidic-control system. The dissolving solution 344 may be held within the production chamber 304 and permitted to dissolve the material of the solid target 326. After a designated time period, the solution (now called product solution) may be directed out of the production chamber 304 and into a system that is configured to process the solution to obtain the radioisotopes.

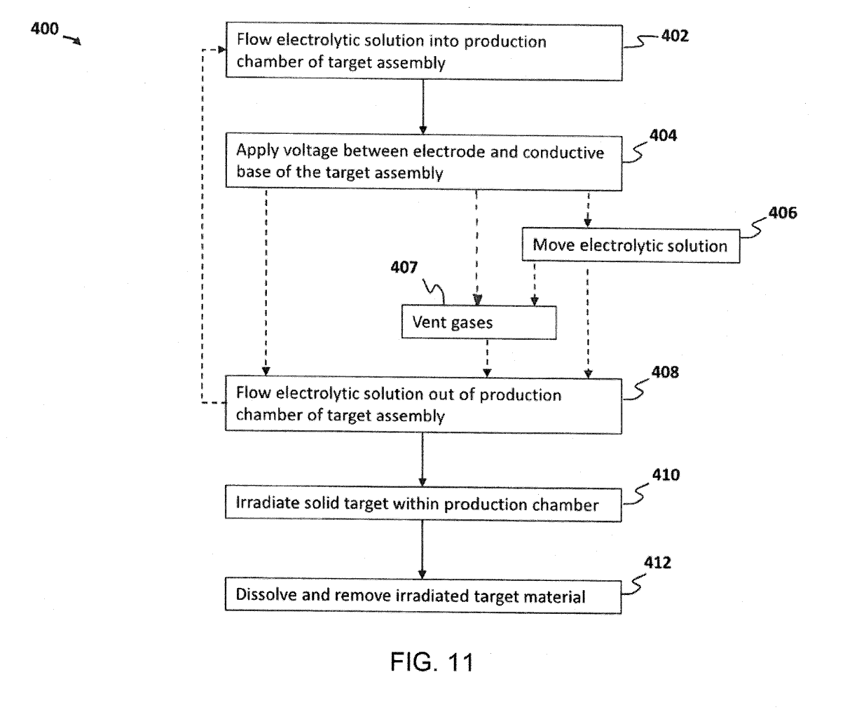

FIG. 11 illustrates a method 400 in accordance with an embodiment. The method 400, for example, may employ structures or aspects of various embodiments (e.g., isotope production systems, target systems, and/or methods) described herein. The method 400 may be, for example, a method of generating a solid target or a method of generating radioisotopes. In some embodiments, the method 400 may be automated. For example, a one or more circuits and/or a control system including one or more processors and a storage medium may execute one or more steps of the method 400. The storage medium may store programmed instructions that are accessible by the one or more processors. In other embodiments, one or more operations may be performed manually. For embodiments that include multiple target assemblies, the method 400 may be performed to generate a solid target within one or more target assemblies while one or more other target assemblies are receiving the particle beam. After the solid target is generated within the target assemblies, these target assemblies may be irradiated while the other target assemblies receive a dissolving solution to remove the irradiated target. The other target assemblies may then be used to generate a solid target.

The method includes flowing, at 402, an electrolytic solution into a production chamber of a target assembly. The target assembly may include an electrode and a conductive base with surfaces exposed to the production chamber. The electrolytic solution, electrode, and the conductive base may effectively form an electrolytic cell.

At 404, a voltage may be applied between the electrode and the conductive base while the electrolytic solution is within the production chamber, thereby causing an electroplating process. The voltage may be applied by a power source (e.g., power supply, such as a battery or rectifier). Optionally, the electrolytic solution may be moved, at 406, as the voltage is applied, at 404. Movement within the production chamber may be any motion that reduces the likelihood that metal ions in the solution will become more concentrated in certain regions during the electroplating process. As used herein, the phrase “within the production chamber” does not require the solution to be contained within a fixed volume. For instance, the electrolytic solution may be pumped into and out of the production chamber during the electroplating process. The movement may be constant or intermittent. For example, a flow of the electrolytic solution may circulate continuously through the production chamber as the voltage is applied. As another example, the electrolytic solution may be periodically moved (e.g., circulated for one second, hold for one second, circulated for one second, and so on). The electrolytic solution may also experience varying pressure to cause motion of the electrolytic solution.

During the electroplating process, gases may be generated within the production chamber and gather at a gas-accumulating pocket or region of the production chamber. Optionally, at 407, the gases may be vented or removed. For example, a fluidic port may be located adjacent to this gas-accumulating region. The gases may be permitted to flow through the fluidic port. In some embodiments, a pump may be configured to draw the gases through the fluidic port at a rate sufficient for removing the gases or sufficient for preventing unwanted effects that the gases may have on the electroplating process. Although operations 406 and 407 appear to be implemented at different times in FIG. 11, it should be understood that the gases may be vented, at 406, and the electrolytic solution may be moved, at 406, concurrently and as the voltage is applied, at 404.

Alternatively, the electrolytic solution may be held in a substantially static manner within the production chamber as voltage is applied. The phrase “substantially static manner” may allow for some motion caused by, for example, a pressure change due to the gases generated within the production chamber. In such instances, the gases may be removed or vented as the voltage is applied or after the voltage has been applied.

At 408, the electrolytic solution is directed out of the production chamber. Optionally, a rinsing or aspiration step may be performed after removing the electrolytic solution at 408. Optionally, the rear body section 316 may be subjected to thermal energy (e.g., through a heater) during the electroplating process or after the electrolytic solution has been removed. It should be understood that steps 402, 404, 406, and 408 may be repeated to grow a solid target having multiple layers. Such embodiments may be desirable when, for example, the metal material of the target body may be unable to form a sufficient bond with the target material. Accordingly, one or more base layers of the solid target may be provided between the surface of the target body and the target material that is irradiated. Optionally, after the solid target is completed, one or more fluids (e.g., liquids or gases) may be directed through the production chamber to remove unwanted residue and/or to dry the surfaces of the production chamber. The solid target may also be subjected to heat.

After the solid target is produced, the solid target may be used to generate radioisotopes. More specifically, the solid target may be irradiated, at 410, with a particle beam. At 412, the activated material may be removed. For example, a dissolving solution may be directed into the production chamber and permitted to dissolve the irradiated solid target. The solution within the production chamber (called product solution) may then be removed. The radioisotopes may be recovered/captured from the production solution. It is contemplated that other methods of removing the activated material may be implemented.

Although not shown, the system may include a target-processing system. The target-processing system may be located adjacent to the target assembly and may include a shielded enclosure. The target-processing system may have the equipment and materials used for processing the irradiated solid target into radiopharmaceuticals.

Embodiments may be configured to generate one or more radiopharmaceuticals. Non-limiting examples of the radiopharmaceuticals may include Copper-64 (Cu⁶⁴), Gallium-68 (Ga⁶⁸), Gallium-67 (Ga⁶⁷), Iodine-123 (I¹²³), Iodine-124 (I¹²⁴), Thallium-201 (Tl²⁰¹), Indium-111 (In¹¹¹), Scandium-44 (Sc⁴⁴), Zinc-63 (Zn⁶³), Palladium-103 (Pd¹⁰³), and Cobalt-57 (Co⁵⁷). In particular embodiments, the radiopharmaceuticals generated include at least one of Copper-64 (Cu⁶⁴), Gallium-68 (Ga⁶⁸), Gallium-67 (Ga⁶⁷), Iodine-123 (I¹²³), or Thallium-201 (Tl²⁰¹). However, it should be understood that other radiopharmaceuticals may be generated with embodiments described herein.

The electrolytic solutions (or plating solutions) are based upon the desired solid target. Non-limiting examples of target material include Nickel (Ni), Zinc (Zn), Tellurium (Te), Thallium (Tl), Rhodium (Rh), Cadmium (Cd), or Silver (Ag). The target material may be selected or enriched with designated isotopes, such as Ni⁵⁸, Ni⁶⁴, Zn⁶⁸, or Cd¹¹².

As described herein, the electroplating process may generate a solid target or target layer on an interior surface of the target body or onto a base layer (e.g., copper, gold, or silver) that was previously electroplated onto the interior surface of the target body.

The dissolving solution may be configured for the irradiated solid target. Non-limiting examples of dissolving solutions include hydrochloric acid (HCL), oxidizing alkaline solution, nitric acid (HNO₃), sulphuric acid (H₂SO₄), hydrogen peroxide (H₂O₂), sodium bisulphate (NaHSO₄), or hydrobromic acid (HBr). After dissolving the irradiated solid target, various processing steps may be performed, based on the composition of the solid target or target layer, to generate the radiopharmaceutical. These steps may include, for example, separating, eluting, purifying, or evaporating the product solution.

Embodiments described herein are not intended to be limited to generating radioisotopes for medical uses, but may also generate other isotopes and use other target materials. Also the various embodiments may be implemented in connection with different kinds of cyclotrons having different orientations (e.g., vertically or horizontally oriented), as well as different accelerators, such as linear accelerators or laser induced accelerators instead of spiral accelerators. Furthermore, embodiments described herein include methods of manufacturing the isotope production systems, target systems, and cyclotrons as described above.

As used herein, a “processor” includes processing circuitry configured to perform one or more tasks, functions, or steps, such as those described herein. For instance, the processor may be a logic-based device that performs operations based on instructions stored on a tangible and non-transitory computer readable medium, such as memory. The processor may include one or more ASICs and/or FPGAs. It may be noted that “processor,” as used herein, is not intended to necessarily be limited to a single processor or a single hard-wired device. For example, the processor may include only a single processor (e.g., having one or more cores), multiple discrete processors, one or more application specific integrated circuits (ASICs), and/or one or more field programmable gate arrays (FPGAs). In some embodiments, the processor is an off-the-shelf device that is appropriately programmed or instructed to perform operations, such as the algorithms described herein.

Embodiments may also include a hard-wired device (e.g., one or more electronic circuits or circuitry) that performs one or more operations, tasks, functions, or steps, such as those described herein. The performance may be determined by hard-wired logic. For example, the one or more circuits may be designed to automatically open and close valves and activate pumps in a desired manner.

The one or more circuits or processors may be configured to receive signals (e.g., data or information) from the various sub-systems. The one or more circuits or processors may also be configured to perform one or more steps of the methods set forth herein. Processors may also include or be communicatively coupled to memory or storage medium. In some embodiments, the memory may include non-volatile memory. For example, the memory may be or include read-only memory (ROM), random-access memory (RAM), electrically erasable programmable read-only memory (EEPROM), flash memory, and the like. The memory may be configured to store data regarding various parameters of the system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, or the like). Similarly, the programs may be stand-alone programs, may be incorporated as subroutines in an operating system, may be functions in an installed software package, or the like. The various embodiments are not limited to the arrangements and instrumentality shown in the drawings.

What is claimed is:

1. A system comprising:
a target assembly having a production chamber, the target assembly including an electrode and a conductive base exposed to the production chamber, the target assembly having fluidic ports that provide access to the production chamber;
a fluidic-control system having a storage vessel configured to hold an electrolytic solution and fluidic lines that connect to the fluidic ports of the target assembly, the storage vessel and the production chamber of the target assembly being in flow communication through at least one of the fluidic lines; and
a power source configured to be electrically connected to the electrode and the conductive base, wherein the production chamber, the electrode, and the conductive base form an electrolytic cell when the electrolytic solution is disposed in the production chamber, the power source configured to apply voltage to the electrode and the conductive base to deposit a solid target along conductive base.

2. The system of claim 1, wherein the target assembly includes an intermediate body section disposed between the electrode and the conductive base, the intermediate body section being insulative.

3. The system of claim 1, further comprising one or more circuits or processors configured to:
induce a flow, using the fluidic-control system, of the electrolytic solution into the production chamber;
apply, using the power source, the voltage to the target assembly thereby depositing metal ions onto the conductive base; and
induce a flow, using the fluidic-control system, of the electrolytic solution out of production chamber after the voltage has been applied.

4. The system of claim 3, wherein the target assembly includes an intermediate body section disposed between the electrode and the conductive base, the intermediate body section being insulative.

5. The system of claim 3, wherein the one or more circuits or processors are configured to, while the voltage is applied, at least one of (a) induce a flow of the electrolytic solution within the production chamber or (b) activate a vibrating device that causes vibrations within the production chamber.

6. The system of claim 1, wherein the target assembly includes a foil that covers an opening to the production chamber, the foil defining a portion of the production chamber.

7. The system of claim 1, wherein the target assembly includes an opening to the production chamber that is configured to receive a particle beam, the conductive base being aligned with the opening such that the particle beam is incident upon the solid target along the conductive base.

8. A system comprising:
a particle accelerator configured to generate a particle beam;
a target assembly having a production chamber, the target assembly including an electrode and a conductive base exposed to the production chamber, the target assembly having fluidic ports that provide access to the production chamber;
a fluidic-control system having a storage vessel configured to hold an electrolytic solution and fluidic lines that connect to the fluidic ports of the target assembly, the storage vessel and the production chamber of the target assembly being in flow communication through at least one of the fluidic lines; and
a power source configured to be electrically connected to the electrode and the conductive base, wherein the production chamber, the electrode, and the conductive base form an electrolytic cell when the electrolytic solution is disposed in the production chamber;
wherein the fluidic-control system includes at least one pump in flow communication with the production chamber, the at least one pump configured to induce a flow of the electrolytic solution into the production chamber and, after voltage has been applied by the power source, induce a flow of the electrolytic solution out of the production chamber.

9. The system of claim 8, further comprising a control system including one or more processors and a storage medium that is configured to store programmed instructions accessible by the one or more processors, wherein the one or more processors are configured to control the at least one pump and the power source to:
induce the flow of the electrolytic solution into the production chamber;
apply the voltage to the target assembly thereby depositing a solid target along the conductive base; and
induce the flow of the electrolytic solution out of production chamber after the voltage has been applied.

10. The system of claim 9, wherein the control system is configured to control the particle accelerator to direct the particle beam onto the solid target within the production chamber.

11. The system of claim 9, wherein the electrolytic solution is a second electrolytic solution and wherein, prior to the solid target being deposited, the one or more processors are configured to control the at least one pump and the power source to:
induce a flow of a first electrolytic solution into the production chamber;
apply a voltage to the target assembly thereby depositing a base layer along the conductive base;
induce the flow of the first electrolytic solution out of production chamber after the voltage has been applied, wherein the solid target is deposited along the base layer.

12. The system of claim 8, wherein the target assembly includes an intermediate body section disposed between the electrode and the conductive base, the intermediate body section being insulative.

13. The system of claim 8, wherein, after the particle beam is directed onto the solid target, the at least one pump is configured to flow a dissolving solution into the production chamber, the dissolving solution configured to dissolve the solid target into the solution after the solid target has been activated by the particle beam.

14. The system of claim 8, wherein the target assembly includes an opening to the production chamber that is configured to receive a particle beam, the conductive base being aligned with the opening such that the particle beam is incident upon the solid target along the conductive base.

15. The system of claim 8, wherein the at least one pump is configured to, while the voltage is applied, at least one of (a) induce a flow of the electrolytic solution within the production chamber or (b) hold the electrolytic solution in a substantially static manner within the production chamber.

16. A method of generating a solid target, the method comprising:
flowing an electrolytic solution into a production chamber of a target assembly, the target assembly including an electrode and a conductive base positioned in the production chamber, wherein the production chamber, the electrode, the conductive base, and the electrolytic solution form an electrolytic cell;
applying a voltage to the target assembly thereby depositing a solid target along the conductive base; and
flowing the electrolytic solution out of production chamber after the voltage has been applied.

17. The method of claim 16, wherein the target assembly includes an intermediate body section disposed between the electrode and the conductive base, the intermediate body section being insulative.

18. The method of claim 16, further comprising controlling a particle accelerator to direct a particle beam onto the solid target within the production chamber, wherein, after the particle beam is directed onto the solid target, the method further comprises flowing a dissolving solution into the production chamber, the dissolving solution configured to dissolve the solid target into the solution after the solid target has been activated by the particle beam.

19. The method of claim 16, further comprising venting gases that are generated within the production chamber as the voltage is applied to the target assembly.

20. The method of claim 16, further comprising, while the voltage is being applied, moving the electrolytic solution within the production chamber.
